(19) United States
(12) Patent Application Publication
(10) Pub. No.: US 2025/0191432 A1
(43) Pub. Date: Jun. 12, 2025

(54) SYSTEM FOR CLASSIFYING DOORS STATES

(71) Applicant: Wiliot, Ltd., Caesarea (IL)

(72) Inventors: Ohad SILBERT, Sunnyvale, CA (US); Yu LUO, Ann Arbor, MI (US); Spencer Thomas WESTON, Nashville, TN (US)

(73) Assignee: Wiliot, Ltd., Caesarea (IL)

(21) Appl. No.: 18/537,082

(22) Filed: Dec. 12, 2023

(51) Int. Cl. G07C 11/00; G16Y 20/20; G16Y 40/10

(52) U.S. Cl. CPC G07C 11/00; G16Y 20/20; G16Y 40/10

(57) ABSTRACT

According to a first aspect of the present disclosed subject matter, A method of classifying doors states, comprising: receiving, data packets from a network element, wherein the received data packets include operation characteristics related to the least a first Internet-of-Things (IoT) tag and a second IoT tag, wherein each of the first and second IoT tags is placed on a different location at a door, and wherein the operation characteristics are respectively derived from signals transmitted by the first IoT tag and the second IoT tag; comparing the operation characteristics of the first IoT tag and the second IoT tag with respect to the network element; and classifying a state of the door based on the comparison.

### TECHNICAL FIELD

The present disclosed subject matter generally relates to the Internet of Things (IoT). More particularly, the present disclosed subject matter relates to detecting and determining door states.

### BACKGROUND

An array of multiple storage rooms in warehouses and a plurality of containers containing various types of goods, including food and medicines sensitive to climate conditions, are stored in temperature and humidity-controlled containers. Some goods are susceptible to pests, and all items are at risk of theft.

In such multi-warehouse structures or depots, it is essential to ensure that the doors of containers, repositories, and storage rooms where products are not being loaded or unloaded remain closed.

Existing solutions for monitoring the condition of storage room doors in large-scale warehouses usually require continuous patrols by warehouse workers, leading to increased operating costs and inefficiency. An automated solution involving cameras or other surveillance devices necessitates a direct line of sight between the items and the cameras and can be cumbersome to install and maintain. Moreover, surveillance camera image processing demands complex algorithms and significant computing resources.

Therefore, it would be advantageous to provide a solution that addresses the challenges mentioned above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify critical elements of all embodiments nor to delineate the scope of any or all aspects. Its sole purpose is to present some concepts of one or more embodiments or aspect in a simplified form as a prelude to the more detailed description presented later. For convenience, the term “some embodiments” or “certain embodiments” may be used herein to refer to a single embodiment or multiple embodiments of the disclosure.

According to a first aspect of the present disclosed subject matter, A method of classifying doors states, comprising: receiving, data packets from a network element, wherein the received data packets include operation characteristics related to the least a first Internet-of-Things (IoT) tag and a second IoT tag, wherein each of the first and second IoT tags is placed on a different location at a door, and wherein the operation characteristics are respectively derived from signals transmitted by the first IoT tag and the second IoT tag; comparing the operation characteristics of the first IoT tag and the second IoT tag with respect to the network element; and classifying a state of the door based on the comparison.

In some exemplary embodiments, the method further comprising: providing a notification on the state of the door, wherein the state is either open or closed.

In some exemplary embodiments, the first IoT tag is located at an open position of the door and the second IoT tag is located at a close position of the door.

In some exemplary embodiments, the network element is located in proximity to any of the first IoT tag and the second IoT tag.

In some exemplary embodiments, the operation characteristics of the first IoT tag and the second IoT tag, further comprises: checking if the operation characteristics of the first IoT tag represent higher values than operation characteristics of the second IoT tag; and determining when the door to be at the position of the first IoT tag when operation characteristics of the first IoT tag represent higher values than operation characteristics of the second IoT tag; and determining when the door to be at the position of the second IoT tag when operation characteristics of the second IoT tag represent higher values than operation characteristics of the first IoT tag.

In some exemplary embodiments, checking if the operation characteristics of the first IoT tag represent higher values than the operation characteristics of the second IoT tag is performed with a reference to the network element.

In some exemplary embodiments, the operation characteristics include any one of: a received signal strength indicator (RSSI); a harvesting rate; a charging time; and a charging rate.

In some exemplary embodiments, the signals transmitted by the first and second IoT tags do not explicitly indicate the state of the door.

In some exemplary embodiments, a signal transmitted by the first and second IoT tags includes any one of: a RSSI, and frequency calibration word.

In some exemplary embodiments, the network element is part of a subnet of IoT tags.

In some exemplary embodiments, classifying the state of the door is performed at the network element for at least one subnet, based on the relationship of operation characteristics of the first IoT tag and the second IoT tag within the subnet.

In some exemplary embodiments, a type of the door is any one of: an up/down sliding door, a rolling door, and a swinging door.

In some exemplary embodiments, the method further comprising: generating a log listing state of all doors; retaining the log in a database; and outputting the log to the user's interface.

Some exemplary embodiments further include a device for classifying doors states comprising: one or more processors configured to: receive, data packets from a network element, wherein the received data packets include operation characteristics related to the least a first Internet-of-Things (IoT) tag and a second IoT tag, wherein each of the first and second IoT tags is placed on a different location at a door, and wherein the operation characteristics are respectively derived from signals transmitted by the first IoT tag and the second IoT tag; compare the operation characteristics of the first IoT tag and the second IoT tag with respect to the network element; and classify a state of the door based on the comparison.

Some exemplary embodiments further include a non-transitory computer-readable medium storing a set of instructions for classifying doors states, the set of instructions comprising: one or more instructions that, when executed by one or more processors of a device, cause the device to: receive, data packets from a network element, wherein the received data packets include operation characteristics related to the least a first Internet-of-Things (IoT) tag and a second IoT tag, wherein each of the first and second IoT tags is placed on a different location at a door, and wherein the operation characteristics are respectively derived from signals transmitted by the first IoT tag and the second IoT tag; compare the operation characteristics of the first IoT tag and the second IoT tag with respect to the network element; and classify a state of the door based on the comparison.

### BRIEF DESCRIPTION OF THE DRAWINGS

The subject matter disclosed herein is particularly pointed out and distinctly claimed in the claims at the conclusion of the specification. The foregoing and other objects, features and advantages of the disclosure will be apparent from the following detailed description taken in conjunction with the accompanying drawings.

In the drawings:

FIG. 1 shows a block diagram of a system for classifying door states, in accordance with some exemplary embodiments of the disclosed embodiments;

FIG. 2 schematically depicts the door states classifying system applied in multiple storages within a warehouse, in some exemplary embodiments of the disclosed embodiments;

FIG. 3 schematically depicts the door states classifying system applied in multiple storages, in accordance with some exemplary embodiments of the disclosed embodiments;

FIG. 4 shows a flowchart of classifying door states, in accordance with some exemplary embodiments of the disclosed embodiments; and

FIG. 5 shows a block diagram of a server, in accordance with some exemplary embodiments of the disclosed embodiments.

### DETAILED DESCRIPTION

The embodiments disclosed herein are only examples of the many possible advantageous uses and implementations of the innovative teachings presented herein. In general, statements made in the specification of the present application do not necessarily limit any of the various claimed embodiments. Moreover, some statements may apply to some inventive features but not to others. In general, unless otherwise indicated, singular elements may be plural and vice versa with no loss of generality. In the drawings, like numerals refer to like parts through several views.

One technical solution provided in the present disclosure is classifying the state, i.e., open-close, of an up/down sliding or rolling doors (U-doors). The state of the doors may be detected and determined by utilizing signals correlated with the door's state.

This is achieved by one of the following examples, any combination thereof, or similar methods: —Analyzing RF signals transmitted by passive IoT tags. —Employing IoT tags equipped with capacitance measuring capabilities that detect changes influenced by nearby elements, such as doorposts. —Utilizing IoTs with light sensors to measure variations in illumination caused by door movement, generating a signal for the door to open/close.

It should be emphasized that the RF signals do not explicitly indicate the state of a door. The door may be a garage door, such as that of a warehouse. In another example, the door may be a cargo container door. In yet another example, the door may be of a truck. It should be noted that the disclosed embodiments can be applicable to any door that is either opened vertically or horizontally, where the detection of the door's state is performed without explicit sensors, cameras, and the like.

In some exemplary embodiments, a Network Element (NE) may be positioned near the top of each U-door's doorpost, directed toward the U-door. The NE is complemented by at least one IoT tag, denoted as B-IoT, situated at the bottom of the door, and at least one IoT tag, denoted as T-IoT, situated at the top of the door. Additionally, or alternatively, the NE may be positioned near the bottom of a doorpost.

In the embodiments where the NE is positioned near the top of a doorpost, the U-door is deemed closed when the T-IoT is near the NE, and the B-IoT is far from the NE. When the U-door is open, the T-IoT is far from the NE, and the B-IoT is near the NE.

Another technical solution provided in the present disclosure is the classification of the state, i.e., open-close, of a swinging door (S-doors). The state of the doors may be detected and determined by utilizing signals correlated with the door's state.

In some exemplary embodiments, a Network Element (NE) may be positioned at the center of the head-jamb of each container having two swinging doors, or near the top of a doorpost opposite the hinge's doorpost for containers with a single swinging door. In any case, the NE is directed towards the S-door. In these embodiments, the NE is complemented by at least one IoT, denoted as R-IoT, situated at the right door's top rail next to the lock-side, and at least one IoT, denoted as L-IoT, situated at the left door's top rail next to the lock-side.

In both of the previously mentioned technical solutions, each NE is configured to transmit Radio Frequency (RF) signals to energize nearby IoTs and receive RF signals from nearby IoTs. The received RF signals may indicate operational characteristics, i.e., properties and conditions, of the IoT tags, such as a Received Signal Strength Indicator (RSSI), harvesting rate (measured by packet rate), charging time, charging rate, or any combination thereof from their associated IoT tags. For example, in one embodiment, when the B-IoTs are near the NE, both the RSSI and harvesting rates are higher; thus, the U-door is open.

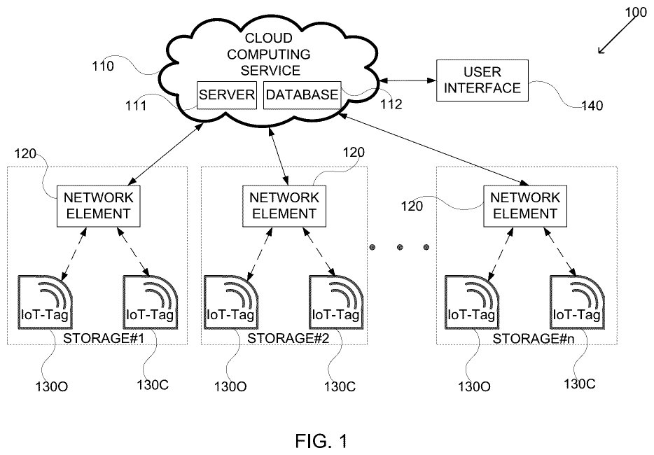

FIG. 1 shows a block diagram of a system 100 for classifying door states, in accordance with some exemplary embodiments of the disclosed embodiments.

System 100 includes a plurality of Network Elements (NE) 120, each of which is supported by at least one Internet of Things (IoT) tag (or tag) 130P and at least IoT tag 130C. In some exemplary embodiments, NEs 120 may be connected to a Cloud Computing Platform (CCP) 110 over the Internet. It should be noted that NE 120 can be connected to the Internet either directly or via a switch, a router (not shown) and the like, or any combination thereof.

For the sake of simplifying the description of the present disclosure IoT 130P and IoT 130P may be collectively referred to as IoT 130.

Additionally, or alternatively, system 100 may further include a User Interface (UI) 140 on which alerts, reports, and other information can be presented to a user. UI 140 can be a personal computer, a smartphone, a laptop, a user terminal, and the like configured to connect to CCP 110 over the Internet. In some exemplary embodiments, the information (such as the reports and alerts) may be reported on a display on the NE 120, if provided.

In some exemplary embodiments, NE 120 includes a low-energy RF transceiver designed to communicate protocols, such as Bluetooth Low Energy (BLE), LoRA, and the like, with IoTs 130. It should be noted that BLE protocols are short-wavelength radio waves operating at a frequency range of about 2.40 to 2.485 GHz.

In some exemplary embodiments, NE 120 may include an application executed by a processor (not shown). The application, when executed, is configured to control the communication with IoT 130 and CCS 110. The processor (not shown) can be realized as one or more hardware logic components and circuits, such as field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

NE 120 may further include a memory component (not shown), such as volatile (e.g., RAM, etc.), non-volatile (e.g., ROM, flash memory, etc.), or a combination thereof. The application may be realized in software constructed of instructions, whether referred to as software, firmware, middleware, microcode, hardware description language, or otherwise. Instructions may include code (e.g., in source code format, binary code format, executable code format, or any other suitable format of code).

In some exemplary embodiments, CCP 110 can be a public cloud, such as Amazon Web Services (AWS); a private cloud; a hybrid cloud; and the like, or any combination thereof.

System 100 may further incorporate a Server 111, realized as a physical machine, a virtual machine implemented in CCP 110; and a Database 112 that can be deployed in CCP 110 and may be connected to Server 111. Database 112 may store events generated by Server 111, identifiers (IDs) of IoT 130, and other signals. Additionally, or alternatively, Server 111 may be configured to generate a log listing the state of all doors in the warehouse based on the states acquired from each NE 120 regarding the doors in its subnet. In some exemplary embodiments, Server 111 can be configured to output the log to UI 140 and retain logs in Database 112.

It will be noted that each NE 120 of a plurality of NE 120 and its associated IoTs 130 will be referred to hereinafter as a “subnet”. Therefore, it will be understood that each storage room, labeled Storage #1 through Storage #n in FIG. 1, is equipped with a subnet, denoted Subnet 1 through Subnet n respectively.

In some exemplary embodiments, IoT 130 may be a passive (battery-less) tag. IoT 130 includes an antenna, a System on a Chip (SoC), and an Energy Accumulator (these elements are not shown in FIG. 1). The antenna is constructed from conductive materials printed on a thin flexible insulating substrate. It is specifically designed for RF transmission in Low-Energy communication protocol (such as BLE) and can also receive RF signals in other frequency bands for electromagnetic energy harvesting.

The SoC, in an embodiment, may include a Controller, a Transmitter, and a Harvester (these elements are not shown in FIG. 1). The Controller is responsible for tasks related to power monitoring, data packet handling, and RF transmission. The Harvester is configured to capture electromagnetic energy received by the antenna and use it to charge the energy accumulator, which stores electrical energy in capacitors and/or chargeable batteries. This stored energy is then used to provide DC voltage to power the SoC.

In an example embodiment, a NE 120 can be realized as an IoT tag powered by a power source (e.g., a battery).

In some exemplary embodiments, IoT 130 may have a form fit and factor of a sticker coated with self-adhesive material on one of its sides, such as for example, an RFID sticker. In the example embodiment, the IoT 130 are affixed on a surface, on doors and/or frames of Storage #1 through Storage #n, and the like.

According to the disclosed embodiments, the state of each door, i.e., open/close, may be detected and determined based on signals received by NE 120 from IoTs 130. Each NE 120 is configured to transmit Radio Frequency (RF) signals to stimulate (energize) IoTs 130 in its subnet and receive RF signals transmitted by the IoT tags 130. The such signals (also referred to as sensing RF signals transmitted by the RF signals may include

a frequency word, a received signal strength indicator (RSSI), and a digitally controlled oscillator (DCO) signal, and the like.

When at least IoT 130C is near NE 120, for example, the RSSI of signals received from IoT 130C are stronger, while the RSSI of signals received from IoT 130P are weaker. Thus, the door is closed.

However, when at least IoT 130P is near NE 120, the RSSI, for example, signals received from IoT 130P are stronger, while the RSSI and of signals received from IoT 130C are weaker. Thus, the door is open.

In an embodiment, the comparison is performed based on the operation characteristics of IoT tag. The operation characteristics may be determined or computed by a NE based on (sensing) signals transmitted by the IoT signals. The operation characteristics may include, for example, a data rate, a harvesting rate, a charging time, a charging rate, and the like. The operation characteristics may also include the RSSI. It should be noted that the sensing signals transmitted by the IoT tags do not indicate the state of the door.

An implementation example of determining the location of IoT tags by low-energy wireless communication is discussed in U.S. patent application Ser. No. 17/823,358, titled “DETERMINING COLLECTIVE LOCATION OF LOW ENERGY WIRELESS TAGS,” assigned to the common assignee, and incorporated herein by reference.

In some exemplary embodiments, data packets transmitted by each IoT 130 include a unique identifier (ID), registered during the production of the IoT 130. The signals sent by the IoT 130 are received at an NE 120, which is configured to determine if the received data packets belong to its subnet and if they were transmitted by IoT 130P or IoT 130C.

It should be noted that RSSI is a measurement of the power present in a received radio signal. Thus, the RSSI value of a signal transmitted by an IoT 130 and received by NE 120 changes as the door to which the IoT 130 is affixed slides or swings to a different position, i.e., moving away from, or close to NE 120.

The at least one IoT 130P may be affixed in different locations, such as the bottom of the door, compared to the at least one IoT 130C, which may be affixed at the top of the door. This placement minimizes false positive readings resulting from the anti-correlated behavior of the signals. Thereby, avoiding the creation of anti-correlation through processes other than opening and closing the door.

In some exemplary embodiments, the determination of the door's state may occur at regular intervals, of up to 5 minutes, to provide a reference dataset for calculating the standard deviations and mean values of RSSI and packet rates. These reference values are used to calculate the z-score for each feature of each IoT 130. A z-score (also called a standard score) provides an estimation of how far from the mean a data point is. The A z-score can be calculated as a measure of how many standard deviations below or above the population mean a raw score is.

In some exemplary embodiments, the number of IoT 130P and the number of IoT 130C, along with a z-score threshold, can be optimized to enhance performance.

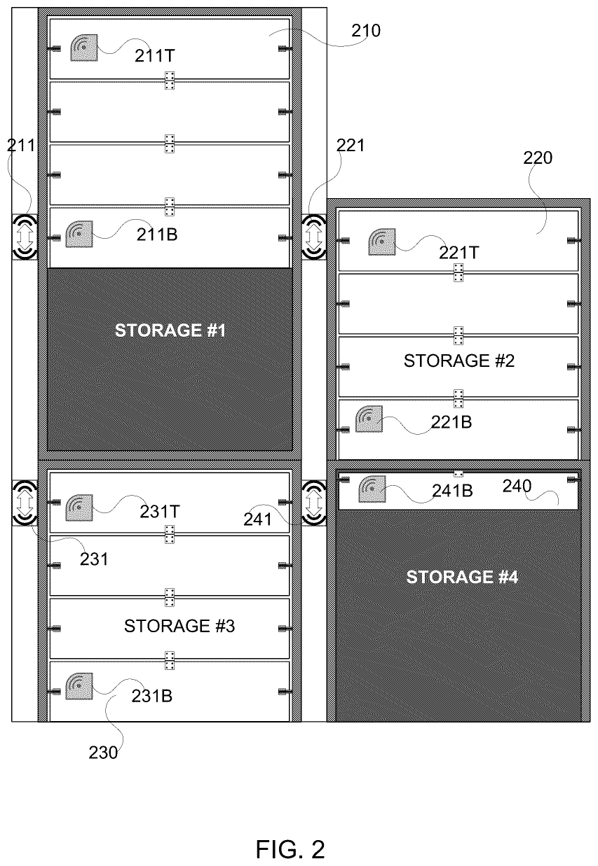

FIG. 2 schematically depicts the door states classifying system applied in multiple storages within a warehouse, in some exemplary embodiments of the disclosed embodiments.

In some exemplary embodiments, System 100 may be utilized to classify the state of storage doors in a warehouse or a depot having a plurality of storages, for example, Storage #1 through Storage #4 as depicted in FIG. 2.

The doors in the embodiment of FIG. 2 can include up/down sliding doors, such as Door 210; rolling doors, such as Door 240; and sideway sliding doors (not shown), collectively referred to in this present disclosure as sliding doors.

It should be noted that the functionality of System 100 is agnostic to the type of sliding doors. Therefore, the description related to the embodiment of FIG. 2 addresses rolling doors, up/down sliding doors, and sideway sliding doors.

In the embodiment of FIG. 2, Subnet 1, installed on Door 210, incorporates an NE 211 in communication with at least one IoT 211B situated at the bottom of the door and at least one IoT 211T situated at the top of the door. Subnet 2, installed on Door 220, incorporates an NE 221 in communication with at least one IoT 221B situated at the bottom of the door and at least one IoT 221T situated at the top of the door. Subnet 3, installed on Door 230, incorporates an NE 231 in communication with at least one IoT 231B situated at the bottom of the door and at least one IoT 231T situated at the top of the door. Subnet 4, installed on Door 240, incorporates an NE 241 in communication with at least one IoT 241B situated at the bottom of the door, and at least one IoT 241T situated at the top of the door.

In some exemplary embodiments, 1^{st} IoT tags, e.g., IoTs 211B, 221B, 231B, 241B; and 2^{nd} IoT tags, e.g., IoTs 211T, 221T, 231T, 241T are practically identical except for the presence of a unique identifier (ID) for each one. This enables network elements to identify IoTs in their subnet and determine their placement on the door, i.e., top or bottom.

In the embodiment of FIG. 2 NEs 211, 221, 231, and 241 may be positioned near the top of each door's doorpost, i.e., Doors 210,220, 230, and 240 respectively, and directed toward their respective door.

It should be noted that the state of the doors is detected and determined based on both the RSSI and harvesting rates of RF signals received by the network element. For example, the RSSI and harvesting rates of signals received by NE 211 from IoT 211B are higher compared to the RSSI and harvesting rates of signals received from IoT 211T. Therefore, Door 210 is deemed open since IoT 211T is much closer to NE 211.

In contrast, RSSI and harvesting rates of signals received by NE 221 from IoT 221T are higher compared to the RSSI and harvesting rates of signals received from IoT 221B. Therefore, Door 220 is deemed closed since IoT 221B is much closer to NE 211.

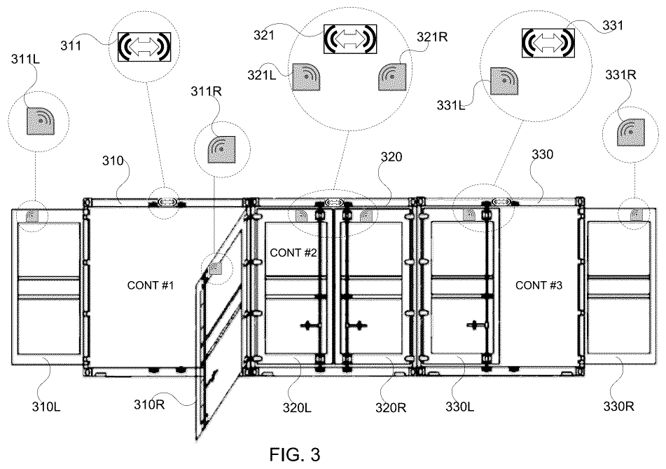

FIG. 3 schematically depicts the door states classifying system applied in multiple containers, in accordance with some exemplary embodiments of the disclosed embodiments.

In some example embodiments, System 100 may be utilized to classify the state of storage doors in a warehouse or a depot having a plurality of storages, for example Containers (CONT) #1 trough CONT #3 as depicted in FIG. 3.

It should be noted that System 100 can be implemented in warehouses or depots having a mixture of storage rooms with sliding doors, such as depicted in FIG. 2, containers with swinging doors, such as depicted in FIG. 3, and the like, or any combination thereof.

In the embodiment of FIG. 3, the doors may be double swinging doors, such as the doors of CONT 310, 320, and 330.

It should be noted that the functionality of System 100 for single-swinging doors and double-swinging is similar.

In the embodiment of FIG. 3, Subnet 1 is installed on CONT 310 and incorporates an NE 311 situated at the center of CONT 310's head-jamb. At this point, NE 311 can be in communication with at least one IoT 311L situated on the top rail of Door 310L next to the lock-side, and at least one IoT 311R situated on the top rail of Door 310R next to the lock-side. Subnet 2, is installed on CONT 320 and incorporates an NE 321 situated at the center of CONT 320's head-jamb.

At this point, NE 321 can be in communication with at least one IoT 321L situated on the top rail of Door 320L next to the lock-side, and at least one IoT 321R situated on the top rail of Door 310R next to the lock-side. Subnet 3 is installed on CONT 330 and incorporates an NE 331 situated at the center of CONT 330's head-jamb. At this point, NE 331 can be in communication with at least one IoT 331L situated on the top rail of Door 330L next to the lock-side, and at least one IoT 331R situated on the top rail of Door 330R next to the lock-side.

In some exemplary embodiments, 1^{st} IoT tags, e.g., IoTs 311L, 321L, 331L; and 2^{nd} IoT tags, e.g., 311R, 321R 331R are practically identical except for the presence of a unique identifier (ID) for each one. This enables network elements to identify IoTs in their subnet and determine in which door they are placed, i.e., left (L) or right (R).

In an embodiment where a container, such as CONT 1, has a single swinging door the network element may be placed on the head-jamb near the lock side post.

It should be noted that the state of the doors is detected and determined based on both the RSSI and harvesting rates of RF signals received by the network element. For example, the RSSI and harvesting rates of signals received by NE 311 from IoT 311L and 311R are weak, therefore, Doors 310L 310R are deemed open since IoT 311L and 311R are far from NE 311.

In another example, the RSSI and harvesting rates of signals received by NE 321 from IoT 321L and 321R are strong, therefore, Doors 320L 320R are deemed closed since IoT 321L and 321R are close to NE 321.

In yet another example, the RSSI and harvesting rates of signals received by NE 331 from IoT 331L are strong, while the signals from 331R are weak, therefore, Door 330L is deemed closed and Door 310R is deemed open, since IoT 331L is close to NE 331 and 331R is far from NE 331.

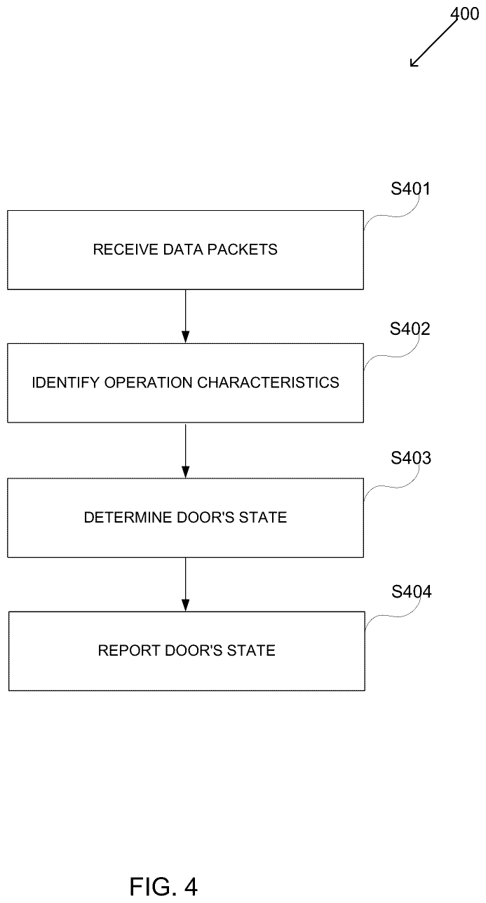

FIG. 4 shows a flowchart 400 illustrating the classification of door states, in accordance with exemplary embodiments of the disclosed system. In an embodiment, the method is performed by Server 111 (FIG. 1).

At S401, data packets are received for at least one IoT tag. The data packets are received via a network element (e.g., the NE 120, FIG. 1) that receives sensing signals from each IoT tag. The sensing signals include, for example, but are not limited to, a frequency word, a received signal strength indicator (RSSI), a digitally controlled oscillator (DCO) signal, and the like, and any combination thereof. A network element may add additional data (or metadata) such as gateway ID, operation characteristics, and the like, to the sensing signals to create data packets.

The operation characteristics are properties and conditions of an IoT tag and be utilized to provide an indication of the distance between a network element and an IoT tag. In an embodiment, the operation characteristics may include an RSSI, a harvesting rate, a charging time, a charging rate, a data rate, and so on. For example, a data rate of an IoT tag can be determined by a network tag based on the rate at which signals are received from the IoT tag.

The network element and the IoT tag may utilize a low-power communication protocol (e.g., BLE). In an embodiment, the network element is located in proximity to one or more tags. Further, as discussed above, a network element may serve as a subnet of IoT tags.

The data packets may be received intermittently for a predefined time window (e.g., 30 seconds). In an example embodiment, the data packets received within the predefined time window may be aggregated for each IoT tag for further analysis. In an embodiment, such aggregation may be performed as follows:

$${Z}_{c o m b i n e} = {\sum }_{signals} ( {\sum }_{nearby tags} \frac{Signal - {ref}_{s i g n a l}}{std \{ {ref}_{s i g n a l} \}} - {\sum }_{distant tags} \frac{Signal - {ref}_{s i g n a l}}{std \{ {ref}_{s i g n a l} \}} )$$

where, Signal is the mean value of, for example, RSSI of the current time window. ref_{signal} is the mean value of RSSI of the reference time window. std {ref_{signal}} is the standard deviation of the RSSI of harvesting rate of a reference time window.

At S402, operation characteristics associated with each IoT tag are identified. In some exemplary embodiments, data packets transmitted by each IoT 130 (of FIG. 1) include a unique identifier (ID) and are received by an NE 120 (of FIG. 1). Thus, such identification may be based on the tag's ID.

In an embodiment, a subset of IoT tags is identified, and operation characteristics associated with each IoT tag in such subnets are identified as well. The subset is identified based on the data packets received for each of the plurality of IoT tags. To this end, it can be ascertained whether the received data packets belong to its subnet and if they were transmitted by IoT 130P or IoT 130C (of FIG. 1). For example, each data rate is associated with an ID of a respective of the IoT transmitting signals at the determined data rate.

At S403, operation characteristics associated with each IoT tag are compared to determine the door's state. In an embodiment, operation characteristics associated various IoT tags in the subnet are compared to determine the door's state. It should be noted that the doors' states classifying may be computed based on the relationship operational characteristics of RF signals within any given subnet, i.e., any given door.

For example, when an operational characteristic is a RSSI, the stronger RSSI and higher signal harvesting rates are measured from IoT tags that are in closer proximity, as compared to the RSSI and harvesting rates from more distant IoT tags. For instance, signals received from IoT 211B (of FIG. 2) have a stronger RSSI due to their close proximity to NE 211 (of FIG. 2). On the other hand, signals received from IoT 211T (of FIG. 2) exhibit a lower RSSI and harvesting rates as they are more distant from NE 211 (of FIG. 2).

S403 may include additional implementations, where, for example, the first IoT tag is located at an open position of the door and the second IoT tag is located at a close position of the door. Further, the network element is located in proximity to any of the first IoT tag and the second IoT tag. In such implementation, comparing the operation characteristics of the first IoT tag and the second IoT tag, further may include: checking if the operation characteristics of the first IoT tag represent higher values than operation characteristics of the second IoT tag; and determining when the door to be at the position of the first IoT tag when operation characteristics of the first IoT tag represent higher values than operation characteristics of the second IoT tag; and determining when the door to be at the position of the second IoT tag when operation characteristics of the second IoT tag represent higher values than operation characteristics of the first IoT tag. Checking if the operation characteristics of the first IoT tag represent higher values than the operation characteristics of the second IoT tag is performed with a reference to the network element.

At S404, the state of a door may be reported. In some exemplary embodiments, NE 120 (of FIG. 1) reports the state of the doors to a notification tag. In another embodiment, Server 111 may be configured to generate a log listing the state of all doors in the warehouse based on the states acquired from all NE 120 (of FIG. 1) regarding the doors in their subnet. Also, Server 111 (of FIG. 1) can be configured to output the log to UI 140 (of FIG. 1) and retain logs in Database 112 (of FIG. 1). In an embodiment, when the state of the door is determined by Server 111, stores the determined state of the door with the respective timestamp and reports the same to on the UI.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

Furthermore, in some implementations, one or more process blocks of FIG. 4 may be performed by a network element that manages communities with multiple IoT tags. In such implementations, classifying the state of the door is performed at the network element for at least one subnet, based on the relationship of operation characteristics of the IoT tags among the subnets. In another implementation, classifying the state of the door is performed at the network element for at least one subnet, based on the relationship of operation characteristics of the IoT tags among different subnets.

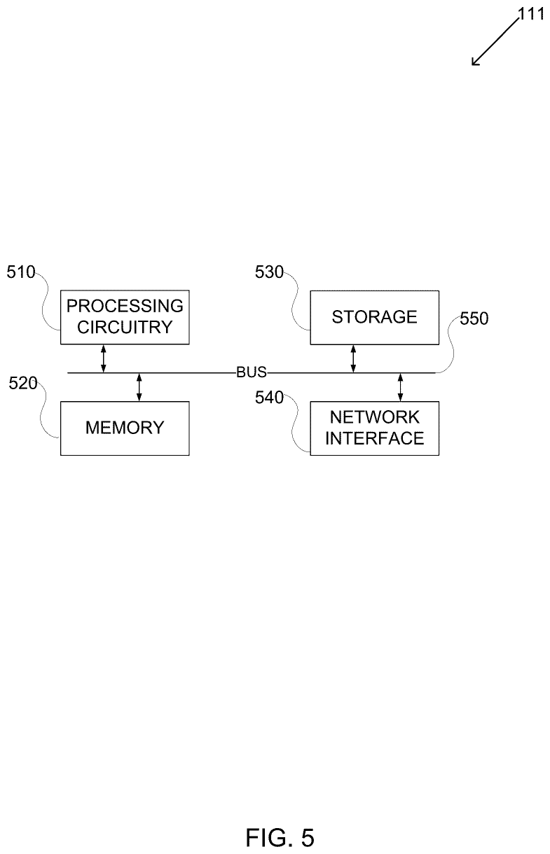

FIG. 5 shows a block diagram of a system for a Server 111, in accordance with some exemplary embodiments of the disclosed embodiments.

Server 111 includes a Processing-Circuitry 510 coupled to a Memory 520, a Storage 530, and a Network-Interface 540. In an embodiment, the components of Server 111 may be communicatively connected via a Bus 550.

The Processing-Circuitry 510 may be realized as one or more hardware logic components and circuits, examples of which are provided above.

Memory 520 may be volatile (e.g., RAM, etc.), non-volatile (e.g., ROM, flash memory, etc.), or a combination thereof. In one configuration, computer-readable instructions to implement one or more embodiments disclosed herein may be stored in Storage 530.

In another embodiment, Memory 520 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the Processing-Circuitry 510, cause the Processing-Circuitry 510 to perform the various processes described herein.

Storage 530 may be magnetic storage, optical storage, and the like, and may be realized, for example, as flash memory or other memory technology, CD-ROM, Digital Versatile Disks (DVDs), solid-state drive (SSD), or any other medium which can be used to store the desired information.

Network-Interface 540 allows Server 111 to communicate with the network elements (gateways) and with the notification device (e.g., user interface 140, FIG. 1) for the purpose of, for example, receiving data, sending data, and the like. Further, Network-Interface 540 allows Server 111 to communicate with the IoT tags for the purpose of collecting frequency words.

It should be understood that the embodiments described herein are not limited to the specific architecture illustrated in FIG. 5, and other architectures may be equally used without departing from the scope of the disclosed embodiments.

The embodiments disclosed herein can be implemented as hardware, firmware, software, or any combination thereof. The application program may be uploaded to, and executed by, a machine comprising any suitable architecture. Preferably, the machine is implemented on a computer platform having hardware such as one or more central processing units (“CPUs”), a memory, and input/output interfaces.

The computer platform may also include an operating system and microinstruction code. The various processes and functions described herein may be either part of the microinstruction code or part of the application program, or any combination thereof, which may be executed by a CPU, whether or not such computer or processor is explicitly shown.

In addition, various other peripheral units may be connected to the computer platform such as an additional network fabric, storage unit and a printing unit. Furthermore, a non-transitory computer-readable medium is any computer-readable medium except for a transitory propagating signal.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions.

What is claimed is:

1. A method of classifying doors states, comprising:
receiving, data packets from a network element, wherein the received data packets include operation characteristics related to the least a first Internet-of-Things (IoT) tag and a second IoT tag, wherein each of the first and second IoT tags is placed on a different location at a door, and wherein the operation characteristics are respectively derived from signals transmitted by the first IoT tag and the second IoT tag;
comparing the operation characteristics of the first IoT tag and the second IoT tag with respect to the network element; and
classifying a state of the door based on the comparison.

2. The method of claim 1, further comprising:
providing a notification on the state of the door, wherein the state is either open or closed.

3. The method of claim 1, wherein the first IoT tag is located at an open position of the door and the second IoT tag is located at a close position of the door.

4. The method of claim 3, wherein the network element is located in proximity to any of the first IoT tag and the second IoT tag.

5. The method of claim 4, wherein comparing the operation characteristics of the first IoT tag and the second IoT tag, further comprises:
checking if the operation characteristics of the first IoT tag represent higher values than operation characteristics of the second IoT tag; and
determining when the door to be at the position of the first IoT tag when operation characteristics of the first IoT tag represent higher values than operation characteristics of the second IoT tag; and
determining when the door to be at the position of the second IoT tag when operation characteristics of the second IoT tag represent higher values than operation characteristics of the first IoT tag.

6. The method of claim 5, wherein checking if the operation characteristics of the first IoT tag represent higher values than the operation characteristics of the second IoT tag is performed with a reference to the network element.

7. The method of claim 1, wherein the operation characteristics include any one of: a received signal strength indicator (RSSI); a harvesting rate; a charging time; and a charging rate.

8. The method of claim 1, wherein the signals transmitted by the first and second IoT tags do not explicitly indicate the state of the door.

9. The method of claim 1, wherein a signal transmitted by the first and second IoT tags includes any one of: a RSSI, and frequency calibration word.

10. The method of claim 1, wherein the network element is part of a subnet of IoT tags.

11. The method of claim 10, wherein classifying the state of the door is performed at the network element for at least one subnet, based on the relationship of operation characteristics of the first IoT tag and the second IoT tag within the subnet.

12. The method of claim 1, wherein a type of the door is any one of: up/down sliding door, a rolling door, and a swinging door.

13. The method of claim 1, further comprising:
generating a log listing state of all doors;
retaining the log in a database; and
outputting the log to a user's interface.

14. A device for classifying doors states comprising:
one or more processors configured to:
receive, data packets from a network element, wherein the received data packets include operation characteristics related to the least a first Internet-of-Things (IoT) tag and a second IoT tag, wherein each of the first and second IoT tags is placed on a different location at a door, and wherein the operation characteristics are respectively derived from signals transmitted by the first IoT tag and the second IoT tag;
compare the operation characteristics of the first IoT tag and the second IoT tag with respect to the network element; and
classify a state of the door based on the comparison.

15. The device of claim 14, wherein the one or more processors are further configured to:
provide a notification on the state of the door, wherein the state is either open or closed.

16. The device of claim 14, wherein the first IoT tag is located at an open position of the door and the second IoT tag is located at a close position of the door.

17. The device of claim 16, wherein the network element is located in proximity to any of the first IoT tag and the second IoT tag.

18. The device of claim 17, wherein the one or more processors, when comparing the operation characteristics of the first IoT tag and the second IoT tag, are configured to:
check if the operation characteristics of the first IoT tag represent higher values than operation characteristics of the second IoT tag; and
determine when the door to be at the position of the first IoT tag when operation characteristics of the first IoT tag represent higher values than operation characteristics of the second IoT tag; and
determine when the door to be at the position of the second IoT tag when operation characteristics of the second IoT tag represent higher values than operation characteristics of the first IoT tag.

19. The device of claim 18, wherein checking if the operation characteristics of the first IoT tag represent higher values than the operation characteristics of the second IoT tag is performed with a reference to the network element.

20. The device of claim 14, wherein the operation characteristics include any one of:
a received signal strength indicator (RSSI);
a harvesting rate;
a charging time; and
a charging rate.

21. The device of claim 14, wherein the signals transmitted by the first and second IoT tags do not explicitly indicate the state of the door.

22. The device of claim 14, wherein a signal transmitted by the first and second IoT tags includes any one of: a RSSI, and frequency calibration word.

23. The device of claim 14, wherein the network element is part of a subnet of IoT tags.

24. The device of claim 23, wherein classifying the state of the door is performed at the network element for at least one subnet, based on the relationship of operation characteristics of the first IoT tag and the second IoT tag within the subnet.

25. The device of claim 14, wherein a type of the door is any one of: up/down sliding door, a rolling door, and a swinging door.

26. The device of claim 14, wherein the one or more processors are further configured to:
generate a log listing state of all doors;
retain the log in a database; and
output the log to a user's interface.

27. A non-transitory computer-readable medium storing a set of instructions for classifying doors states, the set of instructions comprising:
one or more instructions that, when executed by one or more processors of a device, cause the device to:
receive, data packets from a network element, wherein the received data packets include operation characteristics related to the least a first Internet-of-Things (IoT) tag and a second IoT tag, wherein each of the first and second IoT tags is placed on a different location at a door, and wherein the operation characteristics are respectively derived from signals transmitted by the first IoT tag and the second IoT tag;
compare the operation characteristics of the first IoT tag and the second IoT tag with respect to the network element; and
classify a state of the door based on the comparison.
